(19) United States
(12) Patent Application Publication
(10) Pub. No.: US 2019/0135350 A1
(43) Pub. Date: May 9, 2019

(54) SUPPORT STRUCTURE FOR AUTOMOBILE ROOF

(71) Applicants: Hyundai Motor Company, Seoul (KR); Kia Motors Corporation, Seoul (KR); Webasto Donghee Holdings, Ulsan (KR)

(72) Inventors: Hoo Sang PARK, Hwaseong-si (KR); Seong Min GWAK, Yangsan-si (KR)

(73) Assignees: Hyundai Motor Company, Seoul (KR); Kia Motors Corporation, Seoul (KR); Webasto Donghee Holdings, Ulsan (KR)

(21) Appl. No.: 16/030,535

(22) Filed: Jul. 9, 2018

(30) Foreign Application Priority Data
Nov. 8, 2017 (KR) 10-2017-0147717

(51) Int. Cl. B62D 25/06; B60J 7/043

(52) U.S. Cl. CPC B62D 25/06; B60J 7/043

(57) ABSTRACT

A roof support structure of a motor vehicle for supporting a roof glass disposed on a roof rail of the vehicle to reinforce rigidity may include a connection support portion disposed between the roof rail and the roof glass surrounding the roof glass, wherein the connection support portion has front and rear flanges and includes a first joint space disposed between one end portion of the front flange and one end portion of the rear flanges and configured to face the roof rail and a second joint space disposed between the other end portion of the front flanges and other end portion of the rear flanges and configured to face the roof glass.

### CROSS-REFERENCE(S) TO RELATED APPLICATION

The present application claims priority to Korean Patent Application No. 10-2017-0147717 filed on Nov. 8, 2017, the entire contents of which is incorporated herein for all purposes by this reference.

### BACKGROUND OF THE INVENTION

### Field of the Invention

The present invention relates to a support structure for a vehicle roof that can be applied in a unified manner to a vehicle roof regardless of the type of sunroofs. More particularly, it relates to a support structure for a vehicle roof which may be applied in a unified manner to a vehicle to which a fixed type sunroof, a general sunroof, or a panoramic sunroof is fitted.

### Description of Related Art

In general, a roof panel of a motor vehicle is often provided with a sunroof which can be partially opened or fully opened.

The sunroof allows a greater amount of outside air to enter the passenger compartment when it is necessary to ventilate the passenger compartment. Such a sunroof is fitted to the vehicle such that a frame is mounted on the circumferential surface of a through opening formed in a roof panel, a roof glass is mounted pivotally and movably inside the frame and a sunshade is mounted inside the roof glass in a sliding manner.

Meanwhile, in recent years, a panoramic sunroof designed to provide sunroofs for the front and rear seats of the vehicle independently has been developed and employed.

The panoramic sunroof is provided with panoramic roof glasses mounted in a manner of being openable and closeable at the front and rear portions of the roof panel respectively and sunshades are movably mounted below the roof glasses respectively wherein the sunshades are formed to be smaller than the roof glasses.

As described above, the roof of a bodywork is divided into three types: a general roof (a fixed roof), a roof provided with a sunroof and a roof provided with a panoramic sunroof.

For the present reason, to facilitate mass production under actual factory conditions, it is required to unify structure of a roof rail for the panoramic sunroof (hereinafter, the term “panoramic sunroof” is representatively referred to because the panoramic sunroof is substantially the same as the general sunroof in terms of their structure) and that for the general roof in the bodywork assembly process.

If the structure of the roof rail for the panoramic roof is different from that for the general roof, it is required to change an assembly space and line for assembling the bodywork and it will be difficult to secure mass production quality, with the result that mass production cannot be done.

FIG. 1 is a view showing a support structure of a conventional panoramic roof glass, showing a front roof rail for supporting a panoramic roof glass to be mounted right behind a windshield glass of a motor vehicle.

In case where the panoramic sunroof is applied, the structure of the front roof rail 1 includes a triplex structure: a front roof rail lower 1a and a front roof rail upper 1b, of which opposite end portions at opposite sides are coupled together to form a closed cross-section and a reinforce 1c located between the front roof rail lower 1a and the front roof rail upper 1b to reinforce rigidity.

In the instant case, a mastic sealer 6 is applied respectively between the windshield glass 4 and the front roof rail upper 1b and between the panoramic sunroof frame 3 below the panoramic roof glass 2 and the front roof rail upper 1b so that the front roof rail 1 supports the windshield glass 4 and the panoramic sunroof.

However, the mastic sealer 6 cannot be applied in a gap between a roof panel and the front roof rail upper 1b because the gap is large. Accordingly, vibration and noise due to booming during running at a high speed are increased due to decrease in rigidity of the roof panel and the roof panel is collapsed downward at the time of line assembly of the bodywork, resulting in defective appearance and lowering of merchantability.

Furthermore, the related art only includes coupling relationship between the windshield glass and the roof rail and the panoramic sunroof and does not provide any support structure for coupling between the roof glass and the roof rail.

Therefore, there has been a problem that different support structures are required depending on the type or the fixed roof glass of the sunroof mounted on the roof rail of the same type of vehicle.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a support structure disposed between a roof glass and a roof rail so as to be applied commonly to a panoramic sunroof, a general glass roof and a general sunroof which are fitted to the same type of vehicle.

Various aspects of the present invention provide a roof support structure configured in a manner of surrounding a roof glass wherein another object of the present invention is directed to providing a support structure for increasing coupling force between the roof rail and the roof glass.

Objects of the present invention are not limited to the objects as mentioned above and other objects of the present invention, which are not mentioned herein, may be understood by reading the following description and may be more clearly understood by embodiments of the present invention. Furthermore, the objects of the present invention may be realized by the means represented in the appended claims and combinations thereof.

In one aspect of the present invention for accomplishing the objects as mentioned above, a roof support structure of a motor vehicle may include constitutions as follows:

A roof support structure of a motor vehicle for supporting a roof glass disposed on a roof rail of the vehicle to reinforce rigidity including a connection support portion disposed between the roof rail and the roof glass in a manner of surrounding the roof glass wherein the connection support portion has front and rear flanges and may include a first joint space disposed between one-side end portions of the front and rear flanges and configured to face the roof rail and a second joint space disposed between the other-side end portions of the front and rear flanges and configured to face the roof glass.

Furthermore, there is provided a roof support structure of a motor vehicle characterized in that the connection support portion has a closed cross-section surrounding the roof glass.

Furthermore, there is provided a roof support structure of a motor vehicle characterized in that the connection support portion has an H-shaped cross-section in which the front flange and the rear flange are connected to each other.

Furthermore, there is provided a roof support structure of a motor vehicle characterized in that a length in a height direction of the front flange disposed at the front portion of the vehicle is two or more times a length in a height direction of the rear flange.

Furthermore, there is provided a roof support structure of a motor vehicle characterized in that a length in a height direction of the front flange disposed at the rear portion of the vehicle is equal to a length in a height direction of the rear flange.

Furthermore, there is provided a roof support structure of a motor vehicle characterized in that the roof support structure may further include a joint material disposed on at least one of the first joint space and the second joint space.

Furthermore, there is provided a roof support structure of a motor vehicle characterized in that the roof glass is constituted in any one of a fixed roof, a general sunroof and a panoramic sunroof.

According to an exemplary embodiment of the present invention, the following effects may be achieved by combination and use relationship of the foregoing embodiments and configurations described below.

Various aspects of the present invention provide a roof support structure applicable universally to sunroofs and fixed roofs applied to the same type of vehicle so that it has advantageous effects in that quality may be secured without changing a bodywork assembly space or line structure in a factory and mass production may be made under actual factory conditions.

Furthermore, various aspects of the present invention provide adhesive force between the roof rail and the roof glass so that it has an advantageous effect in that durability of the roof glass is enhanced.

Other aspects and exemplary embodiments of the present invention are discussed infra.

It is understood that the term “vehicle” or “vehicular” or other similar term as used herein is inclusive of motor vehicles in general such as passenger vehicles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the present invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing coupling relationship between a windshield glass and a roof glass of a vehicle in the related art;

FIG. 2 is an exploded view of a roof support structure of a vehicle provided with a panoramic sunroof, according to an exemplary embodiment of the present invention;

FIG. 3 is a side cross-sectional view of a roof support structure according to an exemplary embodiment of the present invention;

FIG. 4 is a cross-sectional view of a connection support portion for connecting front and rear portions of a vehicle, according to an exemplary embodiment of the present invention;

FIG. 5 is a side cross-sectional view of a front portion of a vehicle provided with a panoramic sunroof, according to an exemplary embodiment of the present invention; and

FIG. 6 is a side cross-sectional view of a rear portion of a vehicle provided with a panoramic sunroof, according to an exemplary embodiment of the present invention.

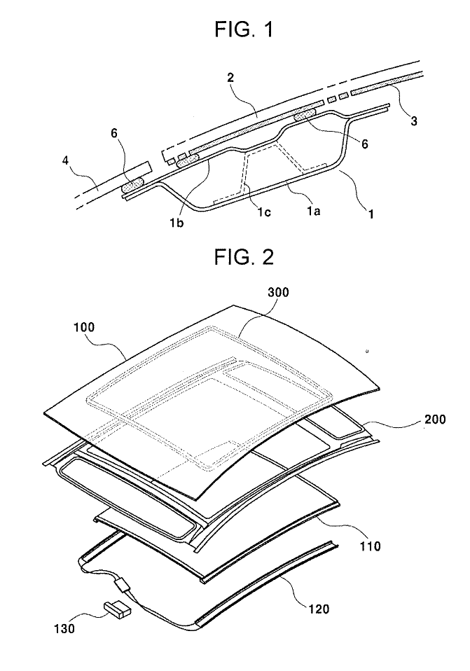

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention will be described below in more detail with reference to the accompanying drawings. The exemplary embodiments of the present invention may be modified in various forms, and the scope of the present invention should not be construed as being limited to the following embodiments. The present exemplary embodiment is provided to more fully describe the present invention to those skilled in the art.

Furthermore, the term “portion,” “part,” or the like as described herein means a unit for performing at least one function or operation and may be implemented by combining hardware.

Furthermore, dividing names of certain components into “first ˜,” “second ˜,” etc. herein is directed to distinguish the components which are in the same relationship from each other, and the present invention is not necessarily limited to the order of those ordinal terms in the following description.

The present invention includes a roof support structure of a motor vehicle, which is applied to the same type of vehicle in a unified manner. In the present disclosure, a roof glass 100 is directed to include general sunroof glass 100, a panoramic sunroof glass 100 and a fixed type glass. In other words, the roof glass 100 means any one of the general sunroof glass 100, the panoramic sunroof glass 100 and the fixed type glass as mentioned above.

FIG. 2 illustrates an exploded view of a roof support structure of a vehicle provided with a panoramic sunroof, according to an exemplary embodiment of the present invention.

As shown, the panoramic sunroof disposed on a roof rail 200 of the vehicle includes the roof glass 100, a guide rail 120 configured to allow opening portion of the roof glass 100 to move and a motor assembly 130 for transmitting driving force to the roof glass 100. Furthermore, the panoramic sunroof may further include a sunshade 110 disposed below a lower surface of the roof glass 100 and configured to be configured for sliding in front and rear directions of the vehicle.

The roof glass 100 of the panoramic sunroof included in an exemplary embodiment of the present invention is formed to be disposed on the roof rail 200. The present exemplary embodiment includes a roof support structure disposed between the roof rail 200 and the roof glass 100.

The roof support structure of a motor vehicle includes a connection support portion 300 disposed between the roof rail 200 and the roof glass 100 wherein the connection support portion 300 may be formed in a closed cross-sectional shape configured in a manner of surrounding the roof glass 100 or the roof rail 200.

The connection support portion may include a front flange 310 and a rear flange 320. In an exemplary embodiment of the present invention, an extension portion 305 connecting the front flange 310 and the rear flange 320, wherein the front flange 310 may include a lower protrusion 312 extending downwards from the extension portion 305 and an upper protrusion 314 extending upwards from the extension portion 305 and wherein the rear flange 320 may include a lower protrusion 322 extending downwards from the extension portion 305 and an upper protrusion 324 extending upwards from the extension portion 305, such that it has an H-shaped cross-section because the front flange 310 and the rear flange 320 are configured to protrude respectively in an up and down direction of the vehicle so that a first joint space 330 where the roof rail 200 faces the connection support portion 300 and a second joint space 340 where the roof glass 100 faces the connection support portion 300 are provided.

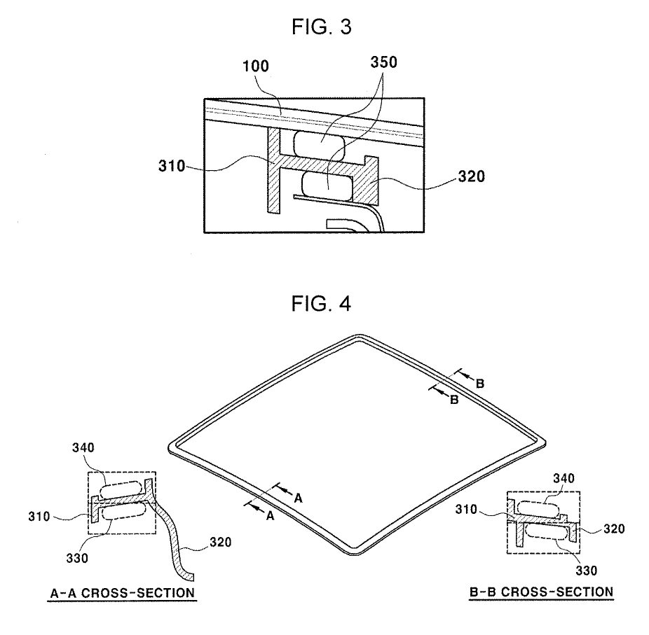

FIG. 3 illustrates a side cross-sectional view of a connection support portion 300 having an H-shaped section, according to an exemplary embodiment of the present invention.

As shown, the connection support portion 300 includes the front flange 310 and the rear flange 320 wherein each of the front flange 310 and the rear flange 320 is configured to protrude in a height direction of the vehicle.

Furthermore, a length in a height direction of the rear flange disposed at the front portion of the vehicle is two or more times a length in a height direction of the front flange disposed at the front portion of the vehicle.

Provided between the front flange 310 and the rear flange 320 which are configured as mentioned above are joint materials 350 for joining the roof rail 200 and the roof glass 100 and the connection support portion 300 mutually wherein the first joint space 330 disposed between the roof rail 200 and the connection support portion 300 and the second joint space 340 configured to allow the roof glass 100 and the connection support portion 300 to contact with each other may be provided.

The first joint space 330 may include a joint material 350 to be disposed between the roof rail 200 and the connection support portion 300 and the second joint space 340 may include a joint material 350 disposed between the roof glass 100 and the connection support portion 300 wherein the joint materials 350 are disposed respectively within spaces between the front flange 310 and the rear flange 320 and is configured to absorb shock between the roof rail 200 and the roof glass 100 and the connection support portion 300.

Moreover, the joint material 350 disposed in at least one of the first joint space 330 and the second joint space 340 may include a resin material or a mastic sealer to increase adhesive force between the loop rail 200 and the roof glass 100 and the connection support portion 300.

FIG. 4 illustrates a perspective view of a roof support structure of a motor vehicle, according to an exemplary embodiment of the present invention.

As shown, the roof support structure according to an exemplary embodiment of the present invention forms a closed cross-section configured in a manner of surrounding the roof glass 100 of the vehicle.

One end portion of the roof support structure disposed at the front portion of the vehicle has an H-shaped cross-section. A length of the front flange 310 in a height direction is configured to be two or more times a length of the rear flange 320 in the height direction thereof.

Furthermore, the roof support structure disposed at the rear portion of the vehicle may be constituted in an H-shaped sectional configuration in which the front flange 310 and the rear flange 320 have substantially the same height as each other.

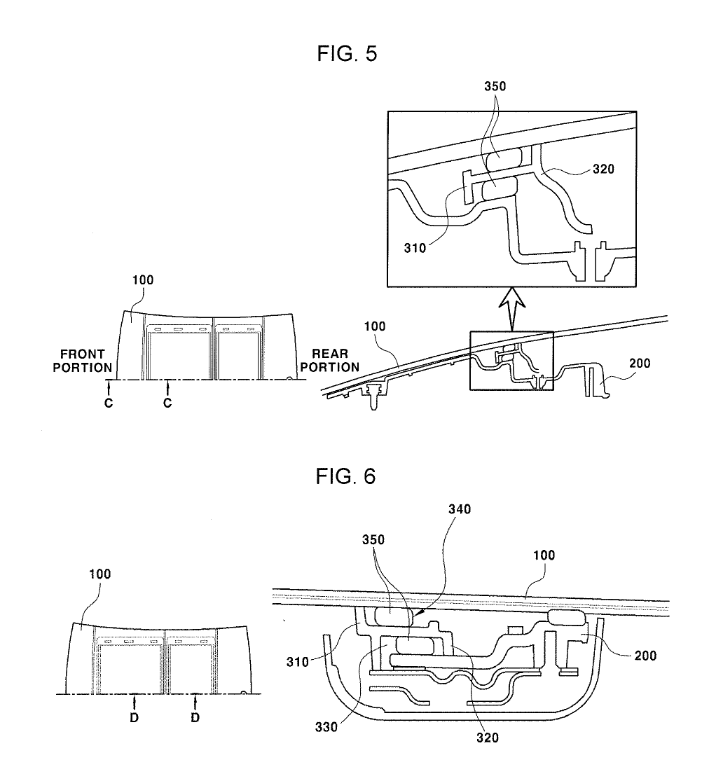

FIG. 5 illustrates a side cross-sectional view showing coupling relationship of a connection support portion 300 disposed at the front portion of the vehicle, according to an exemplary embodiment of the present invention.

As shown, the present exemplary embodiment includes a first joint space 330 facing the roof rail 200 and a second joint space 340 facing the roof glass 100, which form a front flange 310 and a rear flange 320 forming a connection support portion 300 and correspond to spaces formed by the front flange 310 and the rear flange 320 respectively.

The rear flange 320 has a height two or more times a height of the front flange 310 such that it is disposed in the space between the roof glass 100 and the roof rail 200 along inclination of the front portion of the vehicle.

In other words, the connection support portion 300 is configured to be disposed in the space which may be defined depending on the degree of the inclination of the roof rail 200 and the roof glass 100 wherein the rear flange 320 of the connection support portion 300 disposed at one end portion of the front portion of the vehicle may be configured to have a length two or more times a length of the front flange 310.

On the other hand, FIG. 6 illustrates a side cross-sectional view of a connection support portion 300 at the rear portion of the vehicle provided with the panoramic sunroof.

As shown, the rear connection support portion 300 is configured such that a front flange 310 and a rear flange 320 thereof have substantially the same height as each other.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A roof support structure of a vehicle for supporting a roof glass disposed on a roof rail of the vehicle to reinforce rigidity, the roof support structure comprising:
a connection support portion disposed between the roof rail and the roof glass and surrounding the roof glass,
wherein the connection support portion includes:
a front flange and a rear flange;
a first joint space disposed between a first end portion of the front flange and a first end portion of the rear flange and configured to face the roof rail; and
a second joint space disposed between a second end portion of the front flange and a second end portion of the rear flange and configured to face the roof glass.

2. The roof support structure of claim 1, wherein the connection support portion has a closed cross-section surrounding the roof glass.

3. The roof support structure of claim 1, wherein the connection support portion includes an extension portion connected to the first and second flanges between the first and second flanges.

4. The roof support structure of claim 3,
wherein the first flange includes a lower protrusion extending downwards from the extension portion to form the first end portion of the front flange and an upper protrusion extending upwards from the extension portion to form the second end portion of the first flange, and
wherein the second flange includes a lower protrusion extending downwards from the extension portion to form the first end portion of the rear flange and an upper protrusion extending upwards from the extension portion to form the second end portion of the second flange,

5. The roof support structure of claim 1, wherein the connection support portion has an H-shaped cross-section in which the front flange and the rear flange are connected to each other.

6. The roof support structure of claim 1, wherein a length in a height direction of the rear flange is at least two times a length in a height direction of the front flange disposed at a front portion of the vehicle.

7. The roof support structure of claim 1, wherein a length in a height direction of the front flange disposed at a rear portion of the vehicle is substantially equal to a length in a height direction of the rear flange.

8. The roof support structure of claim 1, further including a joint material disposed in at least one of the first joint space and the second joint space.

9. The roof support structure of claim 1, wherein the roof glass is constituted in one of a fixed roof, a general sunroof and a panoramic sunroof.
